(19) United States
(12) Patent Application Publication
(10) Pub. No.: US 2023/0147539 A1
(43) Pub. Date: May 11, 2023

(54) Cylindrical Battery and Method for Manufacturing the Same

(71) Applicant: LG Energy Solution, Ltd., Seoul (KR)

(72) Inventors: Mingyu Kim, Daejeon (KR); Joo Hwan Sung, Daejeon (KR); Minsu Cho, Daejeon (KR); Sunghae Park, Daejeon (KR); Taehyun Kim, Daejeon (KR); Minkook Moon, Daejeon (KR); Minseon Kim, Daejeon (KR)

(73) Assignee: LG Energy Solution, Ltd., Seoul (KR)

(21) Appl. No.: 17/768,987

(22) PCT Filed: Oct. 14, 2020
(86) PCT No.: PCT/KR2020/013965

§ 371 Date: Apr. 14, 2022

(30) Foreign Application Priority Data
Oct. 14, 2019 (KR) 10-2019-0127310

(51) Int. Cl. H01M 50/166; H01M 50/107; H01M 50/121; H01M 50/548

(52) U.S. Cl. CPC H01M 50/166; H01M 50/107; H01M 50/121; H01M 50/548

(57) ABSTRACT

The present disclosure relates to a cylindrical battery comprising: an electrode assembly; and a battery case which houses the electrode assembly and is formed of a resin, wherein the battery case includes an upper case, a side case and a lower case, and wherein a hollow is formed in the side case.

### TECHNICAL FIELD

Cross Citation with Related Application(s)

This application claims the benefit of Korean Patent Application No. 10-2019-0127310 filed on Oct. 14, 2019 with the Korean Intellectual Property Office, the disclosure of which is incorporated herein by reference in its entirety.

The present disclosure relates to a cylindrical battery and a method for manufacturing the same.

### BACKGROUND ART

As energy prices are increasing due to the depletion of fossil fuels and increasing attention is being paid to environmental pollution, the demand for environmentally-friendly alternative energy sources acts as an essential factor for future life. Thus, research into techniques for generating various kinds of power, such as nuclear energy, solar energy, wind energy, and tidal power, is underway, and power storage apparatuses for more efficient use of the generated energy are also drawing great attention.

Moreover, the demand for batteries as energy sources is rapidly increasing as mobile device technology continues to develop and the demand for such mobile devices continues to increase. Accordingly, much research on batteries capable of satisfying various needs has been carried out. In particular, in terms of the material for batteries, the demand for lithium secondary batteries, such as lithium ion batteries and lithium ion polymer batteries, which have advantages such as high energy density, discharge voltage, and output stability, is very high.

The secondary battery may be classified based on the structure of an electrode assembly having a structure in which a positive electrode and a negative electrode are stacked with a separator being interposed between therebetween. For example, the electrode assembly may include a jelly-roll (wound) type electrode assembly in which a long sheet type positive electrode and a long sheet type negative electrode are wound with a separator being interposed therebetween, a stacked (laminated) type electrode assembly in which pluralities of positive electrodes and negative electrodes cut to a predetermined size are sequentially stacked with separators being interposed therebetween, and the like. In recent years, in order to solve problems caused by the jelly-roll type electrode assembly and the stacked type electrode assembly, there has been developed a stacked/folded type electrode assembly, which is a combination of the jelly-roll type electrode assembly and the stacked type electrode assembly, having an improved structure in which predetermined numbers of positive electrodes and negative electrodes are sequentially stacked with separators being interposed therebetween to constitute a unit cell, after which a plurality of unit cells is sequentially wound in the state of having been placed on a separation film.

These electrode assemblies are housed in a pouch case, a cylindrical can, a prismatic case, and the like depending on the purpose of use, thereby producing a battery.

Among them, the cylindrical battery has the advantages of being easy to manufacture and having a high energy density per weight, and thus, is used as an energy source for various devices ranging from portable computers to electric vehicles.

FIG. 1 is a schematic diagram illustrating a conventional cylindrical battery.

Referring to FIG. 1, the cylindrical battery 10 is manufactured by housing a jelly-roll type electrode assembly 12 in a cylindrical case 13, injecting an electrolyte solution in the cylindrical case 13, and coupling a top cap 14 to an opened upper end of the cylindrical case 13. The jelly-roll type electrode assembly 12 has a structure, in which a positive electrode 12a, a separator 12b and a negative electrode 12c are sequentially stacked to be wound in a round shape. A cylindrical center pin 15 is inserted into a central part of the electrode assembly 12. The center pin 15 functions to fix and support the electrode assembly 12, and also functions as a passage for discharging a gas generated through internal reactions during charging/discharging and operation.

Since the cylindrical case 13 of such a conventional cylindrical battery 10 has a single-layer structure made of a metal material, heat is easily discharged to the outside. Therefore, when the cylindrical battery 10 is used in a low-temperature environment, an internal heat generated in a charge and discharge process is easily discharged to the outside, which causes a problem that the performance of the battery is rapidly reduced.

### DETAILED DESCRIPTION OF THE INVENTION

### Technical Problem

It is an object of the present disclosure to provide a cylindrical battery provided with a battery case having excellent heat insulating properties.

However, the problem to be solved by the embodiment of the present disclosure is not limited to the above-mentioned problem, and can be variously expanded within the scope of the technical idea included in the present disclosure.

### Technical Solution

A cylindrical batter according to one embodiment of the present disclosure includes: an electrode assembly; and a battery case which houses the electrode assembly and is formed of a resin.

The battery case may include an upper case, a side case and a lower case, and a hollow may be formed in the side case.

The side case may include an inner case and an outer case.

The hollow may be formed between the inner case and the outer case.

The lower case may include a terminal connection part.

A stepwise-type step may be formed on the side surface of the terminal connection part.

The lower case may include a mounting space corresponding to the shape of the terminal connection part.

The terminal connection part may be made of a metal material.

A negative electrode tab of the electrode assembly may be electrically connected to the terminal connection part.

The upper case may include a first coupling part.

The side case may include a second coupling part.

The first coupling part may be a latch.

The second coupling part may include a groove to which the latch is fastened.

The first coupling part may include a screw thread or a screw valley.

The second coupling part may include a screw thread or a screw valley that is coupled to the screw thread or the screw valley.

A method for manufacturing the cylindrical battery may include the steps of: manufacturing an upper case; connecting the upper case to a side case, and connecting a terminal connection part to a lower case.

The upper case may be fastened to the side case in snap-fit manner.

The upper case may be coupled to the side case by a screw thread/screw valley coupling method.

The upper case may be manufactured by injection molding.

The terminal connection part moves in a direction in which gravity acts in the housing part of the battery case to be mounted in a mounting space in the lower case.

### Advantageous Effects

As described above, the cylindrical battery according to the embodiment of the present disclosure can exhibit excellent heat insulating properties by including a battery case formed of a resin and having a hollow formed therein.

### BRIEF DESCRIPTION OF THE DRAWINGS

FIG. 1 is a schematic view showing a conventional cylindrical battery.

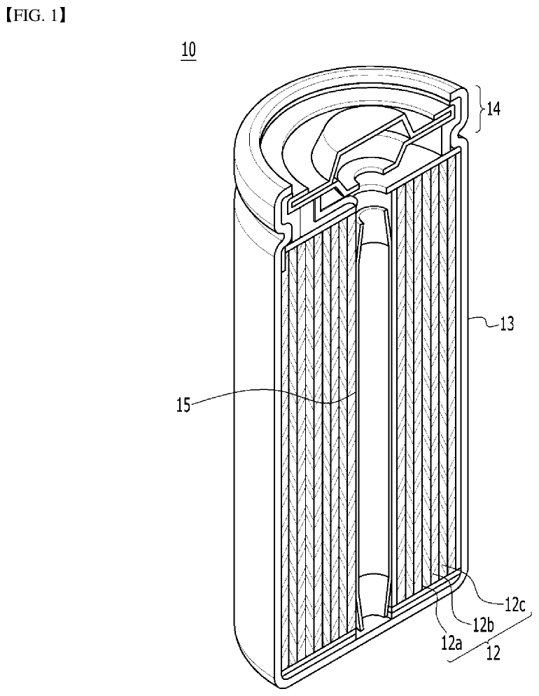

FIG. 2 is a schematic view showing a cylindrical battery according to an embodiment of the present disclosure.

FIG. 3 is a schematic diagram showing that the terminal connection part of FIG. 2 is coupled.

FIG. 4 is a schematic view showing a cylindrical battery according to another embodiment of the present disclosure.

FIG. 5 is a schematic view showing that the upper case of FIG. 4 is separated.

FIG. 6 is a schematic view showing a cylindrical battery according to yet another embodiment of the present disclosure.

FIG. 7 is a schematic view showing that the upper case of FIG. 6 is separated.

### DETAILED DESCRIPTION OF THE EMBODIMENTS

Hereinafter, various embodiments of the present disclosure will be described in detail with reference to the accompanying drawings so that those skilled in the art can easily implement them. The present disclosure may be modified in various different ways, and is not limited to the embodiments set forth herein.

Further, throughout the specification, when a portion is referred to as “comprising” or “including” a certain component, it means that the portion can further include other components, without excluding the other components, unless otherwise stated.

Further, throughout the specification, the “hollow” means an empty space in a vacuum state.

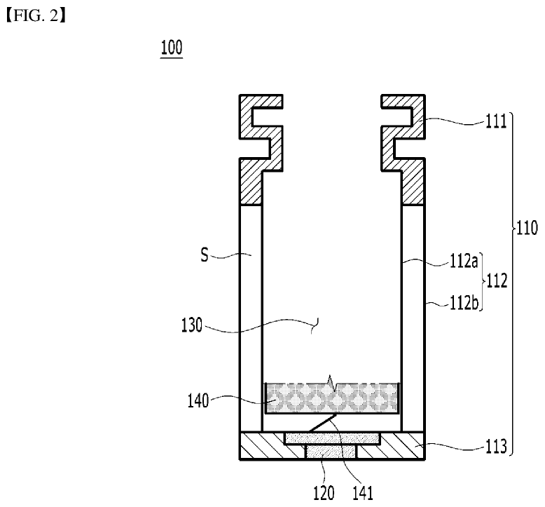

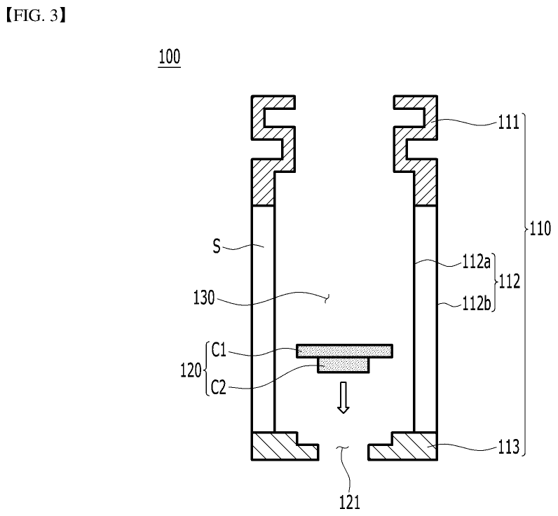

FIG. 2 is a vertical cross-sectional view showing a cylindrical battery according to an embodiment of the present disclosure. FIG. 3 is a schematic diagram showing that the terminal connection part of FIG. 2 is coupled.

Referring to FIGS. 2 and 3, the cylindrical battery 100 may include a top cap (not shown), a battery case 110, a terminal connection part 120, and an electrode assembly 140. The electrode assembly 140 may be housed inside the battery case 110. For convenience of description, a part of the electrode assembly 140 is not shown in the figure.

The top cap may be mounted on the top of the electrode assembly 140. The top cap may have a structure including a safety vent (not shown) and an electric power interrupting device (not shown). Further, the top cap may have a structure that does not include the safety vent and the electric power interrupting device.

The battery case 110 may include an upper case 111 , a side case 112 , and a lower case 113 . The side case 112 may include an inner case 112a and an outer case 112b.

The battery case 120 may be formed of a resin. The resin is not particularly limited, but for example, it may be Teflon. Since the battery case 120 formed of a resin has lower thermal conductivity than a metal can, heat generated in the charging/discharging process of the cylindrical battery 100 may be maintained in the cylindrical battery 100 for a longer period of time.

The upper case 111 may have a shape in which the beading process has already been completed. Because such shape can be manufactured by injection molding, the manufacturing process of the cylindrical battery 100 may be simplified. The upper case 111 may be formed as a single layer. Further, the upper case may have a structure connected to the inner case 112a and the outer case 112b.

The inner case 112a is located on the housing part 130 side in which the electrode assembly is housed, and the outer case 112b may have a structure exposed to the outside in a form surrounding the inner case 112a. The inner case 112a and the outer case 112b may have a cylindrical shape, and the diameter of the inner case 112a may be formed smaller than the diameter of the outer case 112b. A space S spaced apart by a predetermined distance may be formed between the inner case 112a and the outer case 112b. The space S may be hollow. The space S maintained in a vacuum state has a lower thermal conductivity than the metal can structure formed as a single layer, so that an excellent heat insulating effect can be exhibited. Therefore, heat generated in the charging/discharging process of the cylindrical battery 100 may be maintained in the inside of the cylindrical battery 100 for a long period of time.

The lower case 113 may have a structure connected to the inner case 112a and the outer case 112b. The inner case 112a and the outer case 112b may be formed on the edge part of the lower case 113. The lower case 113 may be formed as a single layer. Further, a terminal connection part 120 may be formed in the central part of the lower case 113. In addition, the lower case 113 may have a structure in which a mounting space 121 corresponding to the shape of the terminal connection part 120 is formed.

The terminal connection part 120 may formed of a metal material. A negative electrode tab of the electrode assembly 140 may be electrically connected to the terminal connection part 120. Therefore, the terminal connection part 120 may be a negative electrode terminal of the cylindrical battery 100.

The terminal connection part 120 may have a shape in which two or more low-height cylinders are stacked. Because the cylinders have different cross-sectional diameters, the side surface of the terminal connection part 120 may have a structure in which a stepwise-type step is formed. In one example, the terminal connection part 120 may have a structure in which a cylinder C1 having a large cross-sectional diameter is stacked on a cylinder C2 having a small cross-sectional diameter.

Therefore, the terminal connection part 120 may move in a direction in which gravity acts in the housing part 130 to be mounted in the mounting space 121.

The terminal connection part 120 and the mounting space 121 may be coupled through various connection structures. In one example, a connection part between the terminal connection part 120 and the mounting space 121 may be coupled to each other by forming a screw thread and a screw valley. Further, rubber O-rings may be included at a connection part between the terminal connection part 120 and the mounting space 121. Through the above coupling, it is possible to prevent the electrolyte solution from leaking to the outside.

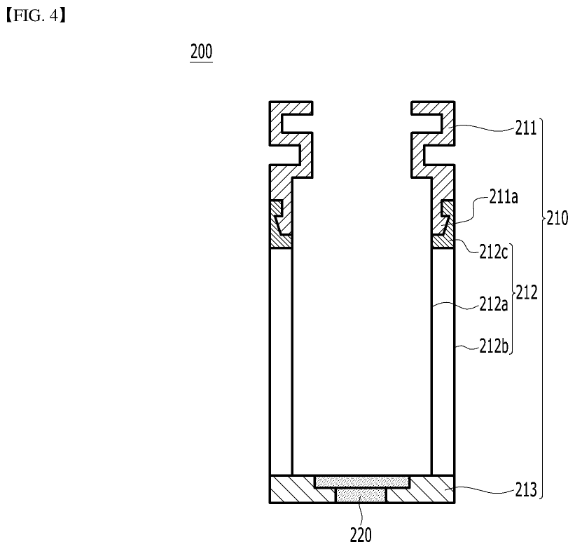

FIG. 4 is a schematic view showing a cylindrical battery according to another embodiment of the present disclosure.

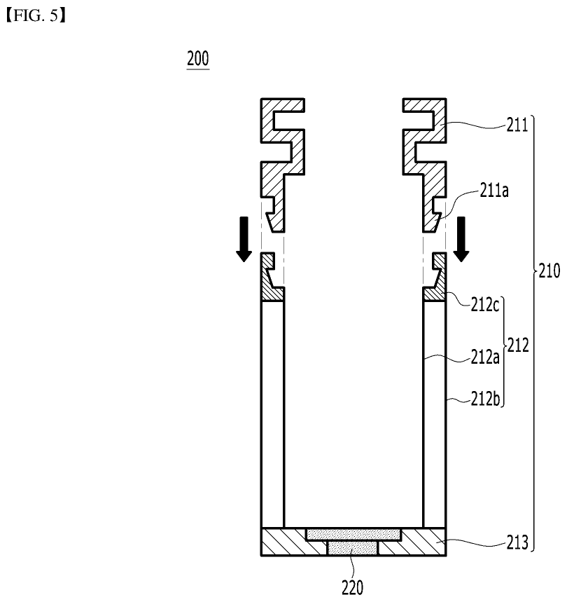

FIG. 5 is a schematic view showing that the upper case of FIG. 4 is separated.

Referring to FIGS. 4 and 5, the cylindrical battery 200 may include a top cap (not shown), a battery case 210, a terminal connection part 220 , and an electrode assembly (not shown). The battery case 210 may include an upper case 211, a side case 212 , and a lower case 213.

The upper case 211 may include a first coupling part 211a. The upper case 211 may be coupled to the side case 212 via the first coupling part 211a. The first coupling part 211a may be a latch.

The side case 212 may include an inner case 212a, an outer case 212b, and a second coupling part 212c. The side case 212 may be coupled to the upper case 211 via the second coupling part 212c. The second coupling part 212c may include a groove structure capable of coupling with the latch.

According to such a structure, the upper case 211 and the side case 212 may be fastened in snap-fit manner. This has the effect of simplifying the manufacturing process of the cylindrical battery 100.

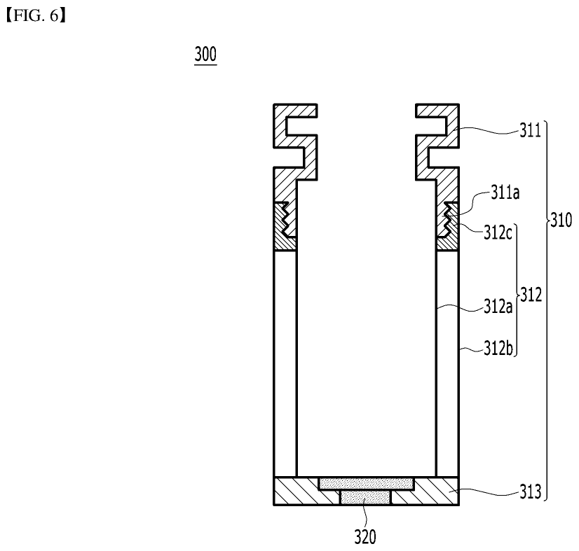

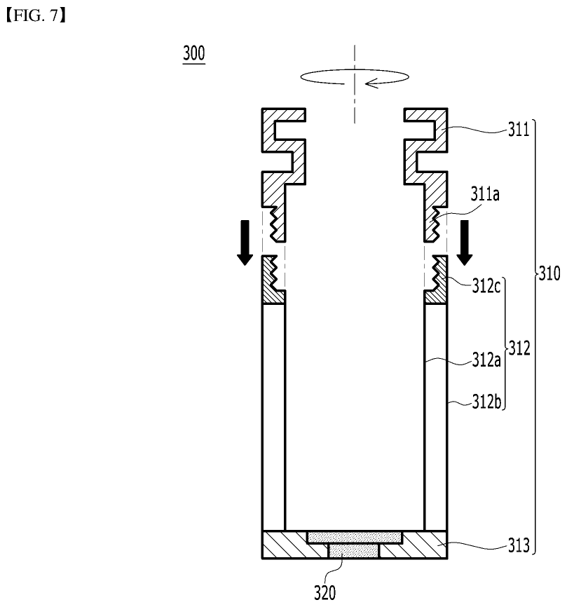

FIG. 6 is a schematic view showing a cylindrical battery according to yet another embodiment of the present disclosure. FIG. 7 is a schematic view showing that the upper case of FIG. 6 is separated.

Referring to FIGS. 6 and 7, the cylindrical battery 300 may include a top cap (not shown), a battery case 310, a terminal connection part 320 , and an electrode assembly (not shown). The battery case 310 may include an upper case 311, a side case 312, and a lower case 313. The side case 312 may include an inner case 312a and an outer case 312b.

The upper case 311 may include a first coupling part 311a. The upper case 311 may be coupled to the side case 312 via the first coupling part 311a. The first coupling portion 311a may include a screw thread or a screw valley.

The side case 312 may include an inner case 312a, an outer case 312b, and a second coupling part 312c. The side case 312 may be coupled to the upper case 311 via the second coupling part 312c. The second coupling portion 312c may include a screw thread or a screw valley.

According to such as structure, the upper case 311 can be rotated and coupled to the side case 312. This has the effect of simplifying the manufacturing process of the cylindrical battery 300. In addition, the upper case 311 can be easily separated from the side case 312 if necessary.

It will be appreciated by those skilled in the art that various applications and modifications can be made without departing the sprit and scope of the invention based on the above description.

1. A cylindrical battery comprising:
an electrode assembly; and
a battery case which houses the electrode assembly therein and is formed of a resin,
wherein the battery case includes an upper case, a lower case, and a side case extending between the upper case and the lower case, and
wherein a hollow is formed in the side case.

2. The cylindrical battery of claim 1, wherein:
the side case includes an inner case and an outer case, the outer case extending around the inner case.

3. The cylindrical battery of claim 2, wherein:
the hollow is formed between the inner case and the outer case.

4. The cylindrical battery of claim 1, wherein:
the lower case includes a terminal connection part.

5. The cylindrical battery of claim 4, wherein:
the terminal connection part has a stepwise-type step formed on a side surface thereof.

6. The cylindrical battery of claim 4, wherein:
the lower case defines a mounting space extending therein and having a shape conforming to a shape of the terminal connection part.

7. The cylindrical battery of claim 4, wherein:
the terminal connection part is formed of a metal material.

8. The cylindrical battery of claim 7, wherein:
the electrode assembly has a negative electrode tab that is electrically connected to the terminal connection part.

9. The cylindrical battery of claim 1, wherein:
the upper case includes a first coupling part that is coupled to the side case.

10. The cylindrical battery of claim 9, wherein:
the side case includes a second coupling part that is coupled to the first coupling part.

11. The cylindrical battery of claim 9, wherein:
the first coupling part is a latch that is fastened to the side case.

12. The cylindrical battery of claim 11, wherein:
the side case includes a second coupling part that is coupled to the first coupling part, and the second coupling part includes a groove to which the latch is fastened.

13. The cylindrical battery of claim 9, wherein:
the first coupling part includes a first one of a screw thread or a screw valley that is coupled to the side case.

14. The cylindrical battery of claim 13, wherein:
the side case includes a second coupling part that is coupled to the first coupling part, and the second coupling part includes a second one of the screw thread or the screw valley that is coupled to the first one of the screw thread or the screw valley.

15. A method for manufacturing the cylindrical battery of claim 1, the method comprising the steps of:
manufacturing the upper case;
connecting the upper case to the side case, and
connecting a terminal connection part to the lower case.

16. The method of claim 15, wherein:
the connecting of the upper case to the side case includes fastening the upper case to the side case in a snap-fit manner.

17. The method of claim 15, wherein:
the connecting of the upper case to the side case includes coupling the upper case to the side case by a screw thread/screw valley coupling method.

18. The method of claim 15, wherein:
the manufacturing of the upper case is performed by injection molding.

19. The method of claim 15, wherein:
the connecting of the terminal connection part to the lower case includes moving the terminal connection part in a direction in which gravity acts on a housing part of the battery case thereby mounting the terminal connection part into a mounting space formed within the lower case.
